(19) United States
(12) Patent Application Publication
(10) Pub. No.: US 2016/0040941 A1
(43) Pub. Date: Feb. 11, 2016

(54) COLD TRACK FOR REFRIGERATION PIPING

(71) Applicants: Andrew Luketic, Huntington Beach, CA (US); Ryan Hofman, Long Beach, CA (US); Christine Souza, Huntington Beach, CA (US)

(72) Inventors: Andrew Luketic, Huntington Beach, CA (US); Ryan Hofman, Long Beach, CA (US); Christine Souza, Huntington Beach, CA (US)

(21) Appl. No.: 14/922,108

(22) Filed: Oct. 23, 2015

Related U.S. Application Data
(63) Continuation-in-part of application No. 13/873,193, filed on Apr. 29, 2013.
Application No. 13/873,193 is a continuation of application No. 61/687,559, filed on Apr. 27, 2012.

(51) Int. Cl. F28F 3/12; B23P 15/26

(52) U.S. Cl. CPC F28F 3/12; B23P 15/26

(57) ABSTRACT

A cold track plate which both secures the refrigeration coils to the exterior of the tray well and helps to distribute cooling (or absorb heat) more efficiently solves the problem of inconsistent heat transfer and other inefficiencies in pan cooler assemblies. A pan cooler assembly preferably uses stainless steel threaded studs electrically welded to a conventional pan, and aligning with apertures in a cold track plate having troughs to accommodate a length of refrigeration piping secured against the pan and preferably held by stainless steel nuts urging the cold track plate against the pan for improved and more even thermal transfer.

This is a continuation-in-part of co-pending U.S. patent application Ser. No. 13/873,193 filed Apr. 29, 2013 which was a continuing application of co-pending provisional patent application No 61/687,559 filed Apr. 27, 2012.

### FIELD OF THE INVENTION

The present invention relates to improvements in the field of food processing equipment for properly and efficiently maintaining cold temperatures in a secure manner, and particularly to reduce the occurrences of equipment failure and food spoilage and to provide a reliable equipment design which can withstand different operating conditions without a burdensome expenditure normally associated with customized constructed equipment, nor supervisory chilling attention demanded with less automated equipment.

### BACKGROUND OF THE INVENTION

Commercially available chilling systems for open tray pans are both unreliable and inefficient. Most common designs rely upon the provision of a deep, common tray well which provides a space of about two inches beneath the bottom of the suspended pans and an air circulation system for utilizing air to pass over the portions of the tray well which extend below an upper support area. The open tray pans are to be kept cool based upon chilling of the lower surfaces of the pan. However, open tray pans lose sufficient heat that the cooling which occurs below the suspended support system is taxed to a point that the total common chilling system may not be sufficient to continue to be enable cooling of the other parts of the tray well, other open tray pans and still contain enough cooling power to then effectively distribute the cold air in a manner that will reduce the temperature of all the open pans suspended in the tray well, and any other structures being served by the pan contact cooling mechanism.

The problems with this arrangement are many. First, the air circulating fans within the convection pan cooling area cause cabinet designers to provide an independent source of electrical power to fans that push an air volume within the tray well for distribution of cooling. Second, the electric circulation fans consume electrical power, in addition to the power expended on operating the refrigeration system that provides a source of cooling cold air source. Third the circulation fans have an extremely cold environment and thus are likely to fail, and in a system which is dependent on both refrigeration flow for cooled air and an air fan to distribute the cool air, failure of either causes a system failure. Fourth, where there is a potential for liquid spillage into the tray well, the fans can be exposed and damaged. Fifth, the expanded size of the well that enables airflow, represents an expanded area for thermal loss causing loss of cooling (absorption by surrounding heat) from a larger surface area.

For an example of large area thermal loss, consider a six inch wide well which is eight inches deep, producing an additional four linear inches (two on each side) to total 28 (8+8+6+6) lateral wetted inches. Compare this to a six inch deep, six inch wide well having 24 (6+6+6+6) wetted inches. Here, four additional wetted inches equates to a 22% greater lateral area (ignoring any contribution from the increased bottom or footprint area) in which heat losses can occur (ignoring multipliers for depth of the pans and for any footprint areas for heat transfer at the bottom areas).

In addition, conventional systems do not effectively concentrate the cooling over the surface of a given well in such a way that will reliably assure that safe levels of food temperature will occur. Where the ultimate transfer of cooling from a refrigeration tube is not effectively transferred to another structure, inefficiencies occur because heat is being absorbed at other places than through the pan well. In this case the refrigeration system may spend most of its energy refrigerating passive, room heat absorbing structures not related to the pan wells. The cost of this type of inefficiency in cooling is expensive, both from passive heat losses as well as from the cost of wide area insulation to combat it.

Customers of food service equipment sellers often complain that food product did not stay consistently cold among a given array of pans in a pan cooler well. In addition, different foods can have different temperature requirements; it may be desired to selectively cool some pans more than others. Where a restaurant's temperatures for each category of food are not maintained, spoiled food, sick customers and failing restaurant inspection ratings can result.

What is needed is a system which will remedy the inefficiency inherent in most conventional pan cooler configurations. The needed system should enhance reliability by eliminating the need to depend upon air circulation, while at the same time eliminating the additional space that air flow normally occupies. The needed system should increase heat flow from the pan well, while eliminating as much as possible undesired heat flow from other sources. The needed system should also facilitate overall pan well system insulation from passive thermal losses. The needed system should also increase manufacturing reliability and reproducibility of efficient results, but without requiring a stringent set of design requirements.

### SUMMARY OF THE INVENTION

A system of constructing a pan cooler from construction materials that include an ordinary, commercially available pan is a major advance in the proliferative use of individualized cooling. The use of commercially available pans as starting materials enables significant cost reduction due to the high volume of low cost commercially available pans produced annually. The alternative would involve the “from scratch” construction of a custom cold box structure that could triple the production costs for individually chilled food containment compartments.

In addition, a cost reduction is obtained by taking advantage of the standard sizes of pans and the standard sizes of multi-pan support structures, or pan wells. The selectivity available to the user can include a pan well structure that includes one cooled pan and a multiplicity of other non-cooled pans. The user can add or subtract individual cooled or heated pans at will. The user can decide the configuration and arrangement of the cooled or heated pans within the support, or well. Some larger support arrangements may be able to take advantage of temperature gradients within the array of supported pans, including actively heated or cooled pans and non-actively heated or cooled pans. Users may or may not choose the expense of overall insulation of the pan support where only one or two actively thermally controlled pans may be present.

In the construction of a thermally controlled pan, the provision of a cold track plate which both secures the refrigeration coils to the exterior of the tray well and helps to distribute cooling (or absorb heat) more efficiently over the surface area of the thermally controlled pan was developed to solve the problem of inconsistent heat transfer and other inefficiencies in pan cooler assemblies. Cold track plating helps create the layout for easy installation of the refrigeration piping along the sides of the pan cooler well assembly. This not only speeds up the installation of the completed assembly, but it guarantees a uniform placement of the cooling coil piping. The present invention overcomes the tendency for human errors and inconsistencies in the placement of thermal (refrigeration or heating) tubing, which may be referred to as refrigeration for ease of use in further description.

Further, the process and structures of the invention provide a cold track plating that is in direct contact with a round refrigeration coil and is also connected to the flat side of the exterior of the pan to form the pan cooler well. Traditionally, only a very small part of the refrigeration tube was touching any flat surface of a structure to be thermally controlled, which was not enough contact to effectively keep product cool. The process and configuration of the invention increases the total area that can be cooled, requiring less work from the refrigeration system which increases the overall efficiency.

A cold track plate may be made from sheets of aluminum by providing radiused bend impressions in the material which are sufficient to place about half of the area of the circular cross section refrigeration piping closely aligned with and radially inward (cross sectionally) of the radiused bends of the cold track plate. Refrigeration piping including a continuous length of tubing may be utilized. A three-eighths outer diameter tubing has been found to be an effective and efficient size for use with most pans. The refrigeration tubing can be made of copper or stainless steel. The use of a continuous length of refrigeration tubing is preferable to the use of welded “U” bends, both for savings in construction case as well as potential savings in pressure drop. The tubing can be tied into a header to facilitate distributive flow.

In addition, a thermal mastic may be preferably employed between the refrigeration piping and the providing radiused bends in the material to help the cold track plate to play a significant role in terms of its ability to both absorb cooling (reject heat) and to spread that ability over a wider area. The circular cross section refrigeration piping touching the pan cooler well will transfer cooling (reject heat) as well, but over a much more limited area. Thermal mastic between the circular cross section refrigeration piping and pan cooler well exterior may also aid in heat transfer, but the size and area of close contact that the cold track plate presents to the exterior surface of the pan cooler well is a more significant factor. It has been found that a temperature of at least thirty-two to thirty-four degrees Fahrenheit may be sufficient for a pan cooler well as many applications and food types will not allow an internal temperature of the middle of the six inch pan to exceed and forty degrees Fahrenheit. It has been found that glycol in a refrigerated coolant system will enable achievement of this goal.

The process involves selecting a sheet of heat conductive material, such as aluminum and providing a series of depressions, slots or structures of sufficient depth that the areas of flat heat conductive material between the radiused bends can flatly overlie external surfaces of the pan cooler efficiently. By way of an example, a refrigeration piping system made of copper can be used, as well as the example of a pan cooler well which is significantly longer than wide and which can accommodate six inch by six inch by six inch pans also known as “one sixth” pans will be used for example. The overall size of the sheet of heat conductive material having the radiused depressions, or troughs, formed will depend upon both the size of the external surfaces of the pan cooler well and upon the configuration and size and spacing of the refrigeration piping to be used. It has been found that three-eights of an inch works well as a size for cooling coils, or refrigeration piping, and that a spacing of one and one-half inches taken from center to center of the refrigeration piping works well for most commercial restaurant pan cooler well applications.

Contemplating a pan cooler well which can hold eight of the six inch pans, the most important surfaces, from an efficiency and economy of construction standpoint to apply the cold track plates are the two major length sides. The second most important surface is the pan cooler well bottom. The latter most important surfaces to apply the cold track plates are the two end sides which may be about six inches wide apiece. Insuring that the ends of the pan cooler well are covered may be more of a function of whether there is an unusually hot wall adjacent one or both of the endmost pan cooler wells. Normally the pans, which are aligned in a row, easily receive enough cooling by virtue of being near the side wall and bottom of the pan cooler well, and also being adjacent a pan which is expected to be at the same temperature.

Beginning the installation of the process and device of the invention, a series of pan cooler wells may be typically welded together using “U” shaped spacers to that later installation of a covering finish mask will be facilitated while the dimensioning of the pan cooler wells are preserved. The series of connected pan cooler wells may be inverted so that the outer external area of the pan cooler wells are exposed. The constructor is free to choose a pathway of refrigeration piping, as well as the axial length (taken with respect to the axial length of the refrigeration piping it will support). For a major side along a forty eight inch pan cooler well, a single length of cold track plate can be used, or a series of shorter length of cold track plate can be used. Where a supply of cold track plates may be provided in shorter length it may become a standard item. The overall routing of the refrigeration piping does not depend upon the cold track plate. Further, a series of abutting cold track plates may perform as well or nearly as well as a single long cold track plate.

Once the cold track plates are selected, a series of holes, preferably mid-way between the two radiused refrigeration pipe accommodating areas. The series of holes may be provided during the cold track plate formation process or drilled by hand. A series of threaded members are electrically welding or electrically “tack welded” to the exterior of the pans to provide a structure which can engage the cold track plates and hold them in close thermal contact with the outside of the pan, as well as to to engage a threaded member and to secure the cold track plate closely in contact with the exterior of the pan cooler wells. In the alternative, the holes may be pre-formed in the cold track plates at the time that the radiused bends forming the hemispherical troughs are formed in the cold track plates. Holes of a diameter of about three eighths of an inch may be used. As by example, where a five inch high cold track plate is to be formed with four radiused hemispherical troughs (seen as radiused bends when viewed looking into the cross section), an eight inch high length of plating would be required so that the five inch height of the cold track plating with four radiused troughs would result.

A series of threaded studs are preferable, the threaded studs to be attached to the exterior of the pan cooler wells. The studs may be typically installed using an electrical stud gun which is manually handy spot welder, may be used to attach a stud. The stud may be typically a short length threaded rod. Although brass or copper can be used, it has been experienced that stainless steel threaded studs instead of copper threaded studs are preferable, both for material compatibility with the typically stainless steel pans as well as to combat corrosion, etc. Once the threaded studs are attached to locations and extending axially away from the pan, they should present a configuration that will align with the holes in the cold track plates. Thus, the studs are used to hold the cold track plates against the exterior of the pan cooler wells.

Depending upon the capability of the stud gun, the studs may be attached to the exterior of the pan cooler wells using some representation of the cold track plate holes as a guide or template to reduce errors and insure a matched pattern. The assembler may also provide a distribution header from which the refrigeration piping will attach and may provide a collection header from which the copper refrigeration piping will return the refrigerant after having passed through the refrigeration piping, the refrigerant having absorbed heat from the pan cooler well both directly and through the radiused depressions of the cold track plate.

Once the refrigeration piping is bent to the desired configuration enough that a cold track plate can be placed against the refrigeration piping to be secured to the exterior of the pan cooler well using the cold track plate holes and the studs applied to the exterior of the pan cooler well, a thermal mastic may be applied to the troughs of the cold track plate which will overlie the refrigeration piping. Whether additional thermal mastic will be applied on the flat areas of cold track plate will depend upon the characteristics of the thermal mastic as well as which other considerations were at hand. Then the cold track plates are more securely attached to the exterior of the pan cooler using washers or other attachment structures as needed. Lock washers or stainless steel cap nuts have been found to work well and are especially compatible with stainless steel studs. Stainless steel cap nuts are good for circumstances where the dimensions and tolerances are known. Open nuts can also be used where more uneven materials may require force and displacement along any length of the studs. Stainless steel nuts which are hand tightened have been found to work well. Cap nuts also give a smoother exterior less likely to catch on other structures.

Next, the areas of refrigeration piping which are not covered by the cold track plate are considered. The refrigeration piping not covered will typically be curved with a direction change leading back to the cold track plate. In most cases the resulting area may be negligibly small. In other instances, a non-linear length of cold track plate may be constructed, such at the corners of the pan cooler well, for example. For the ends of the pan cooler well, a short axial length (taken with respect to the axial length of the refrigeration piping it will support) may be provided for each end of the pan cooling well. If it is thought that the passive flow of cooling at (heat absorption by) the ends is negligible, the constructor may leave the ends free of contact with either the pan cooling well or the cold track plate. As an example, an elongate structure can be covered by lengths of refrigeration piping by a long serpentine pattern, or by spiraling around the structure (and thus necessitating refrigeration piping and covering cold track plates at the ends. Many patterns are possible.

Next, one of the most important aspects of the cold track plate occurs as it takes covering insulation externally to insulate the cold track plate from the outside environment along with areas of the pan cooler well which are exposed. Also insulated are any exposed areas of the refrigeration piping not otherwise underneath the cold track plate. The degree to which refrigeration piping extends over lengths not covered by the cold track plate is a function of user choice, the ability to provide cold track plate over shapes and length refrigeration piping which would otherwise be exposed, as measured against time and effort and cost. In further steps, the pan cooler is completed in the style of a cabinet or stand as further insulation and other structures are added to cause it to be of good use in a restaurant environment.

### BRIEF DESCRIPTION OF THE DRAWINGS

The invention, its configuration, construction, and operation will be best further described in the following detailed description, taken in conjunction with the accompanying drawings in which:

FIG. 1 is a side view of a pan cooler well which illustrates one possible layout of refrigeration piping utilizing the cold track plate of the inventive process and device;

FIG. 2 is a sectional end view of the pan cooler well of FIG. 1 and which illustrates the close relationships of the pan cooler well, refrigeration piping and cold track plate of the inventive process and device; and

FIG. 3 is a closeup a sectional end view of the pan cooler well of FIG. 1 which schematically illustrates heat flow; and

FIG. 4 a more magnified view of FIG. 3 illustrating further details thereof.

### DETAILED DESCRIPTION OF THE PREFERRED EMBODIMENT

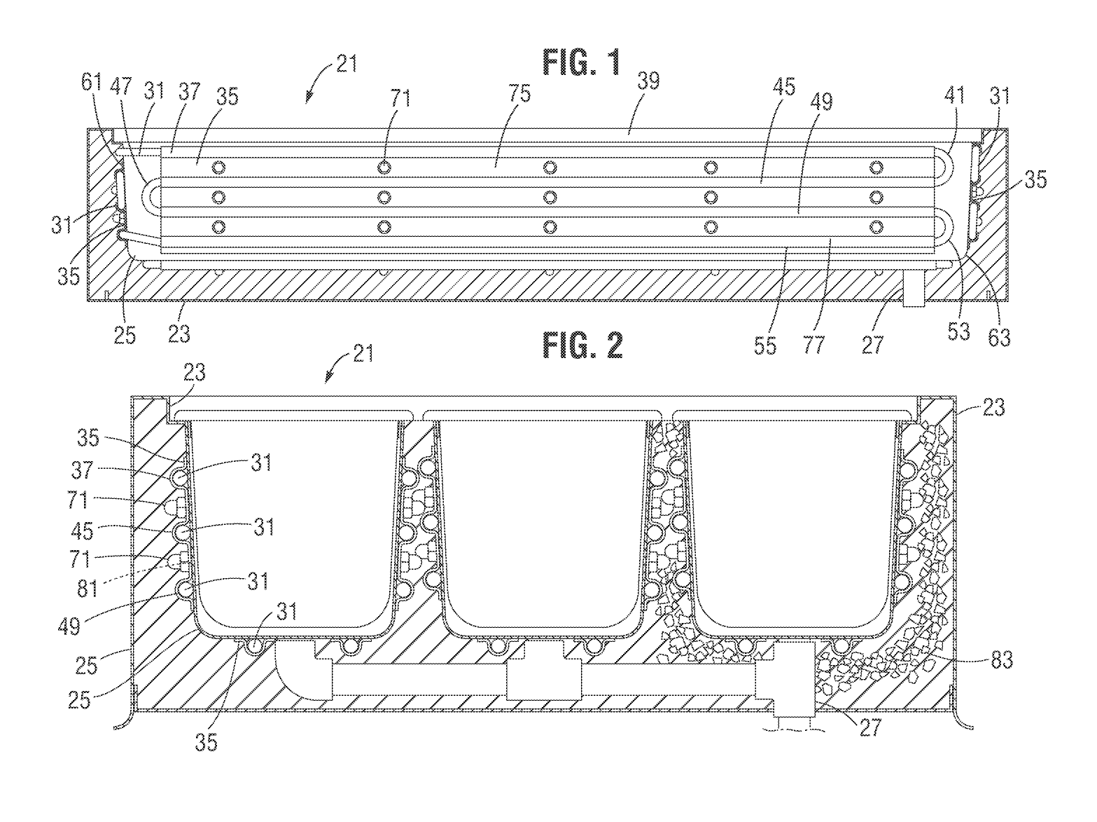

Referring to FIG. 1, a side view of a pan cooler 21 which may have an enclosing support 23, a pan cooler well 25 seen closest to the viewer, and a drain 27 for draining any moisture which occurs within the pan cooler well 25. The surface of the pan cooler well 25 seen is an exterior surface. A length of refrigeration piping 31 is seen at the top left side of the exterior of the pan cooler well 25 and its is shown uncovered. As it is seen to extend to the right, it extends underneath a cold track plate 35 and specifically under a radiused first trough 37 as it extends to the right. Immediately above the first trough 37, the cold track plate 35 ends, such as where further extension might interfere with an upper structure 39.

The refrigeration piping 31 extends the whole length of the cold track plate 35, and emerging at a first turn 41 where the refrigeration piping 31 turns and extends back into the cold track plate 35 underneath a second trough 45. As the refrigeration piping 31 extends back to the left, again the whole length of the cold track plate 35, and emerging at a second turn 47 where the refrigeration piping 31 turns and extends back into the cold track plate 35 underneath a third trough 49. As the refrigeration piping 31 extends back to the right, again the whole length of the cold track plate 35, and emerging at a third turn 53 where the refrigeration piping 31 turns and extends back into the cold track plate 35 underneath a fourth trough 55. The refrigeration piping 31 continues to extend to the left until it emerges from underneath the cold track plate 35 and proceeds around the left side of the pan cooler well 25 and out of sight.

At the extreme left and right sides of FIG. 1, are see a first end 61 of the pan cooler well 25 and a second end 63 of the pan cooler well 25. At the ends 51 and 63, some loop extents of the refrigeration piping 31 are seen which may also be turns and which refrigeration piping 31 may also be secured with cold track plate 35. Also seen are a series of nuts 71 which secure cold track plate 35 to the pan cooler well 25, especially at flat areas 75 of the cold track plate 35 which lie in between the trough areas 37, 45, 49, and 55. Along the lower edge of the cold track plate 35, an extension edge 77 is seen extending beyond the trough 55. This extension edge 77 is used to transmit cooling (heat absorption) beyond the immediate region of the trough areas 37, 45, 49, and 55, and if it were practical to cover every square inch of a pan cooler well 25, that would be optimum, however, the cold track plate 35 is provided to achieve coverage with economy of time and money. The extension edge 77 should be planned for and utilized with the tolerances and capabilities of the constructor in mind.

Referring to FIG. 2, all three of the pan cooler wells 25 in a pan cooler 21 are seen in a sectional view, as well as a version of the cold track plate 35 having only three troughs which surround three lengths of refrigeration piping 31. As can be seen, the pan cooler well 25 can be fairly closely spaced. A threaded shaft 81 (preferably stainless steel) is shown in phantom within of the series of nuts 71 (also preferably stainless steel) which secure cold track plate 35 to the pan cooler well 25. Drain 27 of each of the pan cooler wells 25 is shown as being connected.

An insulation material 83 can be applied to the exterior of any and preferably all of the pan cooler wells 25 in forming the finished pan cooler 21. The advantages include (1) passive areas not covered by the cold track plate 35 will be insulated and thus act as more efficient passive cold sinks, (2) insulation of the exterior surfaces of the cold track plate 35 will serve to prevent heat loss from those areas of the pan cooler wells 25 covered by the cold track plate 35, and (3) attack of any of the (typically) copper refrigeration piping 31 by corrosive atmospheric influences from food, particularly citric acids will be blocked even more fully than any portions which might be coated by the thermal mastic to be shown in FIG. 4.

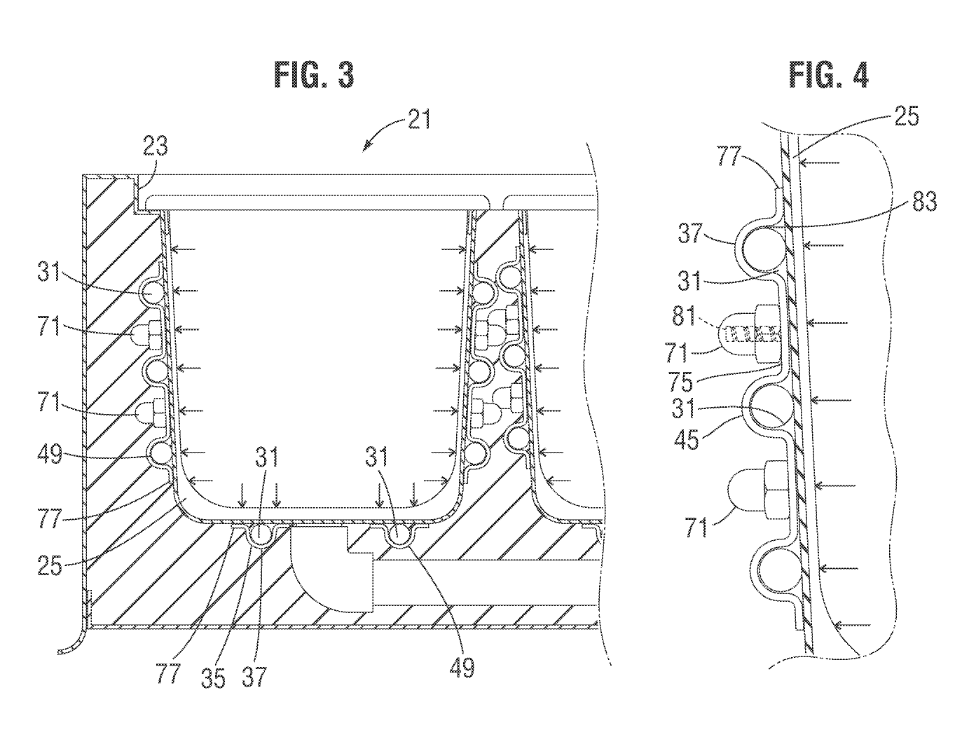

Referring to FIG. 3, a further closeup view of the leftmost of the pan cooler wells 25 seen in FIG. 3 is illustrates and emphasizes more clearly the existence of a cold track plate 35 having only three troughs (of which only troughs 37 and 49 are seen, the middle trough 45 being obscured by the drain 27. Also shown are arrows indicating head flow into the cold track plate 35 and refrigeration piping 31 from within the pan cooler well 25.

Referring to FIG. 4, a further closeup view of the leftmost of the pan cooler wells 25 seen in FIGS. 2 & 3 is seen and illustrates and emphasizes more clearly the degree to which a cold track plate 35 can surround refrigeration piping 31. Also seen is an extension edge 77 at the top of the cold track plate 35. It is preferable to arrange coverage of the cold track plates 35 so that any pairs of extension edges 77 can cover as much area between them as possible without overlapping. Also seen in the upper part of FIG. 4 as a black material between the refrigeration piping 31 and the inside of the trough 37 of the cold track plate 35 is a thermal mastic material which is preferably primarily applied between piping 31 and cold track plate 35, but may be applied elsewhere.

While the present invention has been described in terms of a device and system used for providing more efficient pan cooler assemblies by providing a better way to extract heat from a pan cooler well through refrigeration piping, and in particular a new structure which helps guide the configuration and insulation of a cooling device, the techniques employed herein are applicable to a wide range of devices and methods.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A cold plate assembly comprising:
a continuous length of refrigeration piping;
an area of thermally conductive material having a series of troughs separated by generally non-trough areas for covering the continuous length of refrigeration piping; the non-trough areas of the thermally conductive material having apertures for enabling the thermally conductive material to be attached to a pan cooler well.

2. The cold plate as recited in claim 1 wherein the non-trough areas are planar.

3. The process of assembling a pan cooler comprising the steps of:
forming a cold track plate having an outside surface and an inside surface, the inside surface including a plurality of troughs to accommodatingly covering a length of refrigeration piping;
forming holes in the cold track plate to facilitate attachment of the cold track plate to another structure;
applying a series of threaded studs to an external surface of a pan cooler well in alignment with the holes;
providing a length of refrigeration piping to fit within the plurality of troughs of the cold track plate;
applying a thermal mastic between the inside trough of the cold track plate and the length of refrigeration piping;
attaching the cold track plate to the pan cooler well using a series of threaded fasteners, each engageable with an associated one of the threaded studs.

4. The process of assembling a pan cooler as recited in claim 3 and further comprising the step of applying an insulation layer to the outside surface of the cold track plates and exposed surfaces of the pan cooler not covered by the cold track plates.

5. The process of assembling a pan cooler as recited in claim 3 wherein the threaded studs and the threaded fasteners and the pan cooler well are made of stainless steel.

6. A pan cooler comprising:
a pan having contained sides and an upper opening, the contained sides having an inside and an outside;
a threaded stud attached to the outside of the contained sides of the pan;
a length of refrigeration piping adjacent the outside contained sides of the pan;
a cold track plate having an outside surface and an inside surface, the inside surface including at least one trough for at least partially providing a surrounding cover for the length of refrigeration piping, and at least one aperture for facilitating engagement of the cold track plate against the length of refrigeration piping using the threaded stud.

7. The pan cooler as recited in claim 6 wherein the at least one trough is a plurality of troughs separated from each other by at least one non-trough area.

8. The pan cooler as recited in claim 6 wherein the threaded stud is a plurality of threaded studs and wherein the at least one apertures of the cold track plate is a plurality of apertures, the plurality of threaded studs substantially aligned to fit over associated ones of the plurality of apertures for alignment.

9. The pan cooler as recited in claim 6 and further comprising an insulation layer attached to the outside surface of the cold track plate and exposed surfaces of the pan cooler not covered by the cold track plates.

10. The pan cooler as recited in claim 6 and further comprising an insulation layer attached to the outside surface of at least one of the pan cooler and a length of refrigeration piping not covered by the cold track plate.

11. The pan cooler as recited in claim 6 wherein the threaded stud attached to the outside of the contained sides of the pan is electrically welded to the outside of the contained sides of the pan to extend axially away from a surface of the pan.

12. The pan cooler as recited in claim 11 and further comprising a threaded nut attached to the threaded stud to hold the cold track plate.

13. The pan cooler as recited in claim 7 wherein the non-trough areas of the cold track plate are planar.
